(19) United States
(12) Patent Application Publication
(10) Pub. No.: US 2001/0001528 A1
(43) Pub. Date: May 24, 2001

(54) SYNCHRONOUS MACHINE WITH A HLDER TO SUPPORT PERMANENT MAGNETS IN A CLAW POLE ROTOR

(76) Inventor: ISTVAN RAGALY, SCHWIEBERDINGEN (DE)

Correspondence Address: STRIKER STRIKER & STENBY, 103 EAST NECK ROAD, HUNTINGTON, NY, 11743

(21) Appl. No.: 09/250,315

(22) Filed: Feb. 15, 1999

(30) Foreign Application Priority Data
Feb. 18, 1998 (DE) 198 06 667.8

(51) Int. Cl. H02K 1/27; H02K 21/04

(52) U.S. Cl. 310/263

(57) ABSTRACT

A synchronous machine formed as a generator for a motor vehicle has a stator, a rotor, an excitation system including a plurality of individual poles in the rotor formed as claw poles, a unit for compensation of stray flux in free spaces between the claw poles and including permanent magnets provided in pole plates arranged at axial ends of the rotor, a holder supporting the permanent magnets against centrifugal and axial forces, the holder being composed of two non-magnetic holding rings which centrally surround the excitation system, abut against one another and have an outer contour extending to a lower side of the claw poles, holding arms which are bent on the holding rings in correspondence with a number of poles and extend in the free spaces to the pole plates so as to support the permanent magnets, the holding arms having free ends, holding tongueslaps supported by the free ends of the holding arms in direction toward a rotor shaft, the holding tongues being fixed on inner sides of the pole plates.

### BACKGROUND OF THE INVENTION

The present invention relates to a synchronous machine, in particular a generator for a motor vehicle, which has an excitation system of a plurality for example electrically excited individual poles in a rotor, in form of claw poles excited by an excitation system for example a common excitation coil, in which for compensation of the stray flux permanent magnets are arranged in the free spaces between the axially oppositely oriented claw poles of the pole plates arranged on the axial ends of the rotor, and the permanent magnets are supported by a holder against centrifugal and axial forces and held by it.

A synchronous machine of this type is disclosed for example in the German patent document DE 89 05 353 E1. The permanent magnets in the free spaces between the oppositely directed claw poles are oriented by the holding plates against the centrifugal forces. The holding plates are inserted peripherally in the expansions of the claw poles and fixed, while facing the machine central axis they are supported on a non magnetic sleeve which surrounds the excitation coil. This construction of the permanent magnets requires not only a considerable partial expense which is dependent on the pole number of the synchronous machine, but also requires a considerable mounting expense for the holding plates. The rotor of the synchronous machine is expensive to manufacture. Moreover, the permanent magnets are not exactly oriented in the axial direction against axial impact forces.

As disclosed in U.S. Pat. No. 5,543,676 it is known to insert U-shaped permanent magnets between the excitation coil and the claw poles. The side legs of the permanent magnets are inserted in the free spaces between the claw poles. The permanent magnets extend only to an axial center of the free spaces, since a permanent magnet is inserted by each tip of a claw pole.

Also, a meandering and ring-shaped holder for the permanent magnets is known, which is prefabricated as a unit and inserted during the mounting of the rotor on the pole core with the excitation winding, before the both axial ends of the pole plates are mounted with their claw poles. The claw poles are inserted in the axially open receptacles of the holder as disclosed in the British patent no. 2,281,665 A. This known holder has a complicated construction and is expensive to manufacture. Moreover, the permanent magnets and also the holder are not secured exactly against the centrifugal forces and axial impact forces.

### SUMMARY OF THE INVENTION

Accordingly, it is an object of present invention to provide synchronous machine of this type, in which a holder for the permanent magnets has a simple construction and is produced easily and in a cost favorable manner, so that in a simple way during the mounting of the rotor it is accurately radially and axially fixable.

In keeping with these objects and with others which will become apparent hereinafter, one feature of present invention resides, briefly stated, in a synchronous machine, in which the holder is composed of two non-magnetic holding rings which centrally surround the excitation system and which abut against one anther, and also which extend with their outer contour to the lower side of the claw poles, the holding arms are bent on the holding rings in correspondence with the pole number and extend in the free spaces and to the pole plates so as to support the permanent magnets, and the free ends of the holding arms carry holding tongues which are bent in direction toward the rotor shaft, and the holding tongues, preferably in corresponding troughs, are fixed on the facing inner sides of the pole plates.

The both holding rings with their holding arms and holding tongues are produced as a stamped bending element easily and in a cost favorable manner. The holding rings form with the holding arms and the holding tongues a three-side closed receptacle per each free space, in which the parallelepiped permanent magnet can be inserted. Since the holding tongues are mounted on the pole plates, a radially and axially accurate hold for the holder composed of two holding rings is provided. The holding rings with the permanent magnets can be prefabricated as units, and mounted on the pole plates so that they can be fitted with the pole plates on the axial ends on the pole core with the excitation coil. For this holder only two simple punched bending parts are needed, whose introduction can be easily integrated in a mounting process of the rotor.

In accordance with one embodiment of the present invention, the holding tongues extend to the end region of the excitation coil, and the permanent magnets are axially secured with the holding tongues in both directions.

A fixed connection between the holding tongues and the pole plates can be dispensed with, when the troughs are provided with undercuts in the radial direction, and the holding tongues have the shape corresponding to the shape of the troughs and are inserted in them.

When to the contrary the design is such that the holding rings of the holding arms and the holding tongues are produced of punched bending element of a non-magnetic, weldable material, then the holding tongues can be welded in the troughs with the pole plates.

During the production of the punched bending elements, it must be taken into consideration that with a rotor which has identically wide free spaces between the claw poles extending parallel to the central axis of the machine, the holding arms and the holding tongues can extend on the holder as rays and double bent perpendicularly. In a rotor with free spaces which are identically wide and alternatingly differently inclined to central axis of the machine, the holding arms and the holding tongues can be inclined and bent in correspondence with the inclination on the holder.

The support and stability of the holder in the region of the holding rings can be improved in accordance with an embodiment in which holding projections are formed on the holders between the holding arms and extend inwardly and outwardly. They are bent to improve the stability of the holding rings.

When the holding rings with the permanent magnets and the pole plates are prefabricated as units, then with the mutually nested and oppositely oriented claw poles, during mounting of the rotor it is achieved that the holding rings are arranged on one another so that the holding arms transit directly into one another. The transiting holding arms cover the free spaces from one pole plate to the other pole plate.

The holding rings with the holding arms and the holding tongues form two receptacles per each free space, provided for the permanent magnets and arranged one after the other.

When it is provided that the holding rings between the neighboring free spaces have such bent portions, which extend perpendicular to the longitudinal axes of the free spaces, then to mutually inclined free spaces can be used for parallelepiped-shaped permanent magnets which fill the receptacles of the holder as much as possible. The claw poles close the receptacles of the holder after the mounting of the rotor on both longitudinal sides.

The holding of the permanent magnets in the receptacles of the holder can be improved for facilitation of the mounting. In particular, the permanent magnets can be held by adhesion, form-locking connection or force-transmitting connection in the holder.

In accordance with another embodiment, the sides of the claw poles which face the excitation coil can raise steeper starting from the center of the claw pole than the portions of these sides extending to the corresponding opposite pole plate. In this case a small power loss during the use of the holders with great radial width and the stability is provided. Due to the sandwich-like construction of the permanent magnets, their strength is increased. Moreover, on the assembled permanent magnets, the magnetic layers can be supported radially, so that the abutments or corrugations are engaged and the permanent magnets can be axially secured. The permanent magnets can be however made of one piece with the grooves, in which the corrugations or abutments of the holders engage.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a first embodiment for a punched part, from which a part of a two-part holder can be formed by bending;

FIG. 2 is a view showing a second embodiment for a punched part, from which a part of the two-part holder can be produced by bending;

FIGS. 3 and 4 are views showing both punched bending parts of the two-part holder in a prospective view;

FIG. 5 is a view showing both punched bending parts of FIGS. 3 and 4 in a mounting condition;

FIG. 6 is a partial development of a peripheral view of a rotor of the inventive machine;

FIG. 7 is a partial transverse cross-section through the synchronous machine with a holder mounted in the rotor and provided with permanent magnets;

FIGS. 8-13 are views showing various embodiments of the holding rings of the holder for improving the support and strength; and

FIGS. 14-16 are views showing different variants of the magnetic construction and the axial fixation of the permanent magnets.

### DESCRIPTION OF PREFERRED EMBODIMENTS

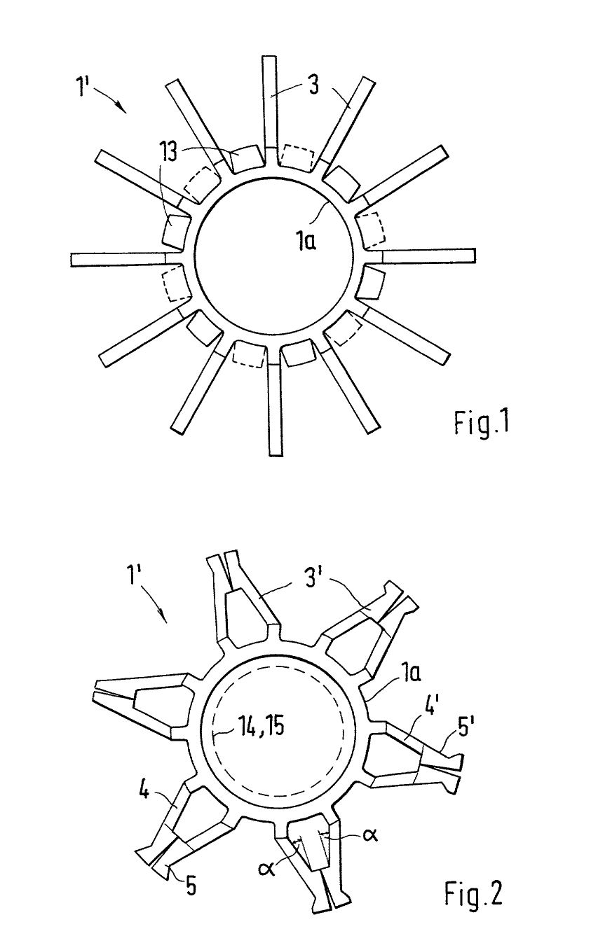

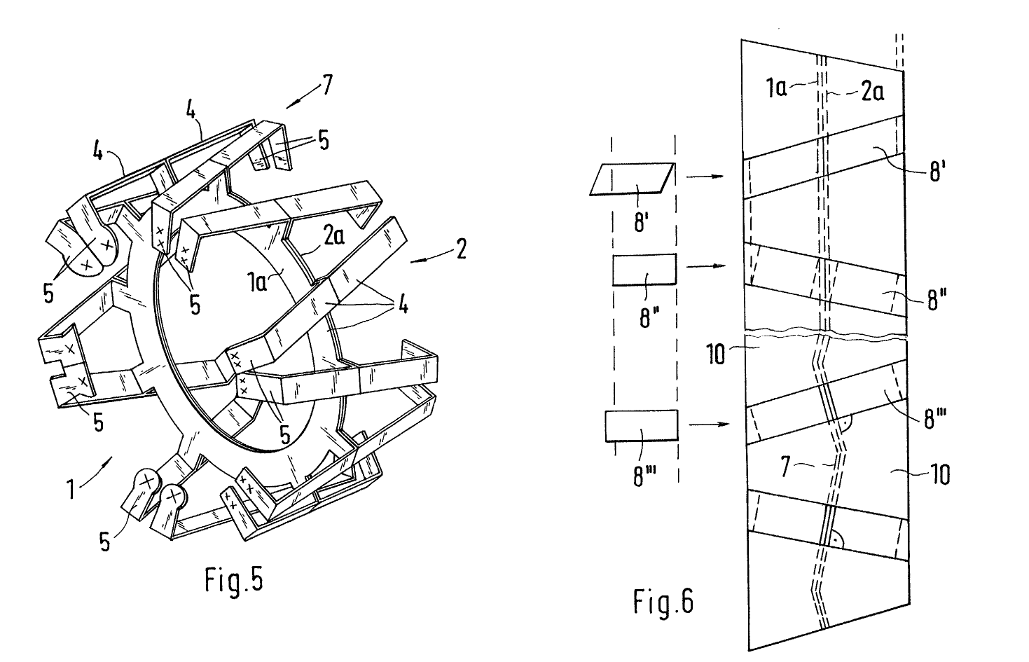

FIG. 1 shows a punched part 1′ which is composed of a holder 1a and ray-shaped arms 3 provided on its periphery and extending in correspondence with a number of poles and a number of the free spaces. Projections 13 are formed between the arms 3. The arms 3 can be bent perpendicularly two times, so that the holding arms 4 and the holding tongues 5 are formed as can be seen in FIGS. 3 and 4. The holder 7 for a rotor is composed of two punched-bending parts 1 and 2 which are identical. From the punched part 1′ in FIG. 1 a part 1 or 2 of a holder 7 is bent, which is suitable for a rotor. The free spaces extend parallel to the central axis of the machine and have identical width.

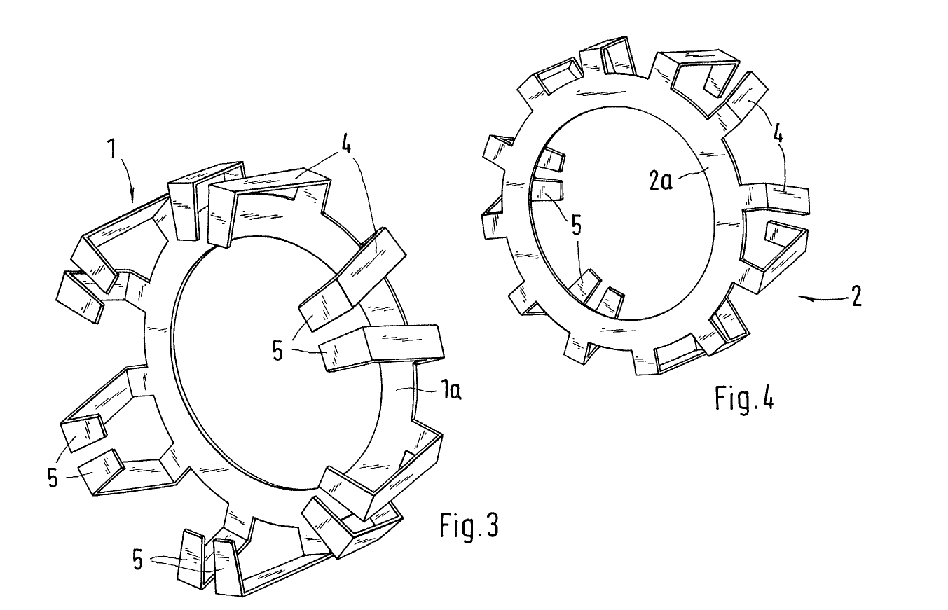

As can be shown from FIG. 2, the arms 3′ can be inclined on the punched part 1′ so that after the double bending of the portions 4′ and 5′ in correspondence with FIGS. 3 and 4, the holding arms 4 and the holding tongues 5 are formed. They are alternatingly inclined in correspondence with the claw angle of the synchronous machine, as the punched bending parts 1 and 2 as shown in FIGS. 3 and 4.

The end portions 5′ of the punched part 1′ can have different shapes, such as shown in FIG. 2. The end portions 5′ can form radial undercuts, which facilitate a radial fixation of the bent holding tongues 5, as illustrated. Further projections 14 and 15 can be formed on the inner periphery of the holding ring 1a. For improving the support and stability of the holding ring 1a, they can be designed and bent differently.

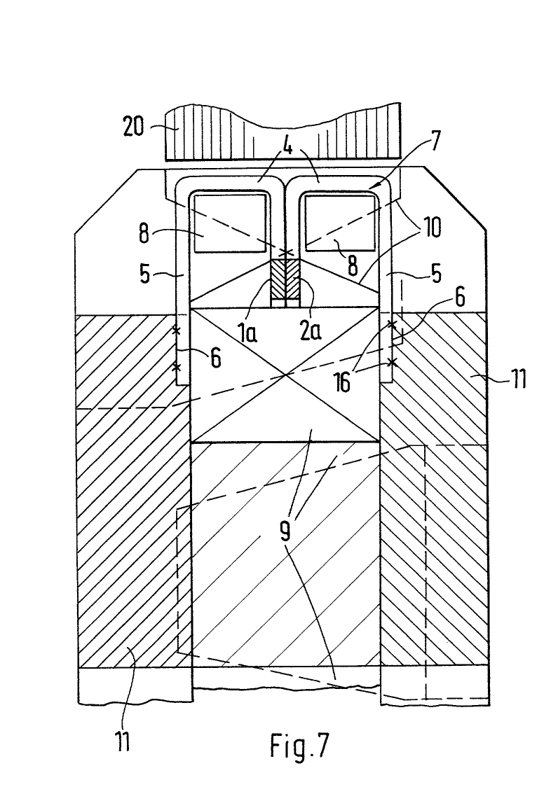

As can be seen from FIG. 5, during mounting of the rotor the both punched bending parts 1 and 2 of the holder 7 are oriented so that the holding arms 4 in correspondence with the free spaces directly transit into one another and fill the free spaces from one pole plate to the other pole plate.

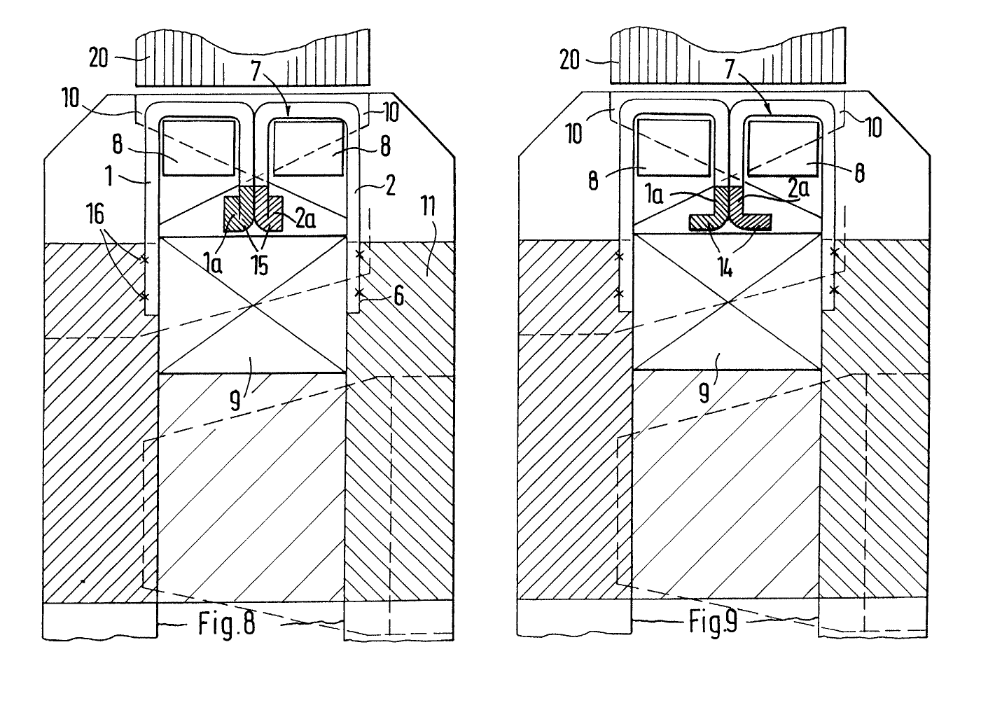

When the holding rings 1a and 2a are located directly planly on one another, then with alternatingly differently inclined free spaces between the claw poles 10 problems occur with the shape of the permanent magnets when they must completely fill the receptacles in the holding ring 7 as the shape of the permanent magnet 8′ shows. If however the parallelopiped-shaped permanent magnets 8″ are inserted, then they can fill the receptacles in an optimal manner. When the holding rings 1a and 2a of the holder are correspondingly bent in the region under the claw poles 10, then the portions of the holding rings 1a and 2a intersect the free spaces at the right angle, and the permanent magnets 8′″ can be utilized which have a parallelopiped-shape and better fill the receptacles as can be seen from FIG. 6.

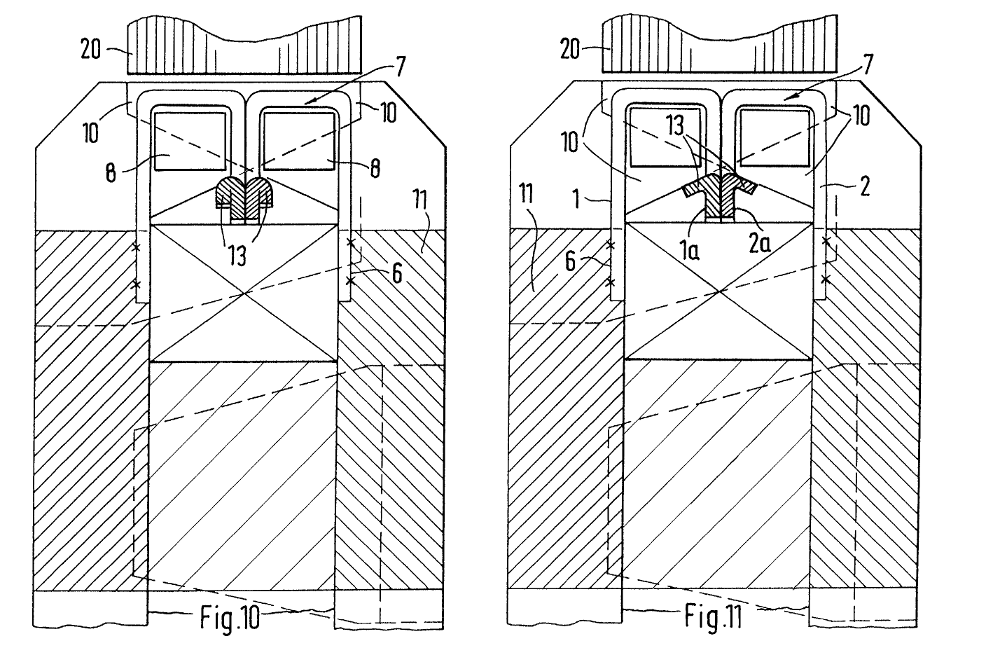

The partial section of FIG. 7 shows the excitation system of the rotor of a synchronous machine with the excitation coil around the pole pore. The rotor is associated with a stator 20 which can be formed in a known manner. The both pole plates 11 with the formed claw poles 10 are premounted with the both parts of the holding ring 7 before the mounting on the excitation system 9. The holding tongues 5 of the holding ring 1a are inserted in correspondingly shaped troughs 6 on the inner side of the left pole plate 10 and fixed in them. For this purpose a form-locking connection with the radial undercut can be sufficient. The holding tongues 5 can be additionally or exclusively welded in the troughs 6 as identified with welding points 16. The bent holding arms 4 form with the holding tongues 5 a three-side closed receptacle for a permanent magnet 8, which is held by glueing, form-locking connection or force-transmitting connection.

The claw poles 10 which laterally adjoin the holding arms 4 complement the receptacles at both axial sides. In the same way, the right pole plate 11 is provided with the holder 2a and the permanent magnet 8. The both thusly prefabricated units are fitted from both axial ends on the excitation system 9. The claw poles 10 are nested in one another and cover the free spaces with the holding arms 4 with the assembled holder 7. Since the holding tongues 5 extend to the region of the end sides of the excitation coil of the excitation system 9, the holding tongues 5 in the mounting condition of the pole plates 11 are fixed axially in both directions.

The holder 7 which is so integrated in the rotor is radially and axially fixed both in the region of the holding rings 1a and 2a and the holding tongues 5. The permanent magnets 8 are reliably held even with high number of revolutions and loaded only with pressure.

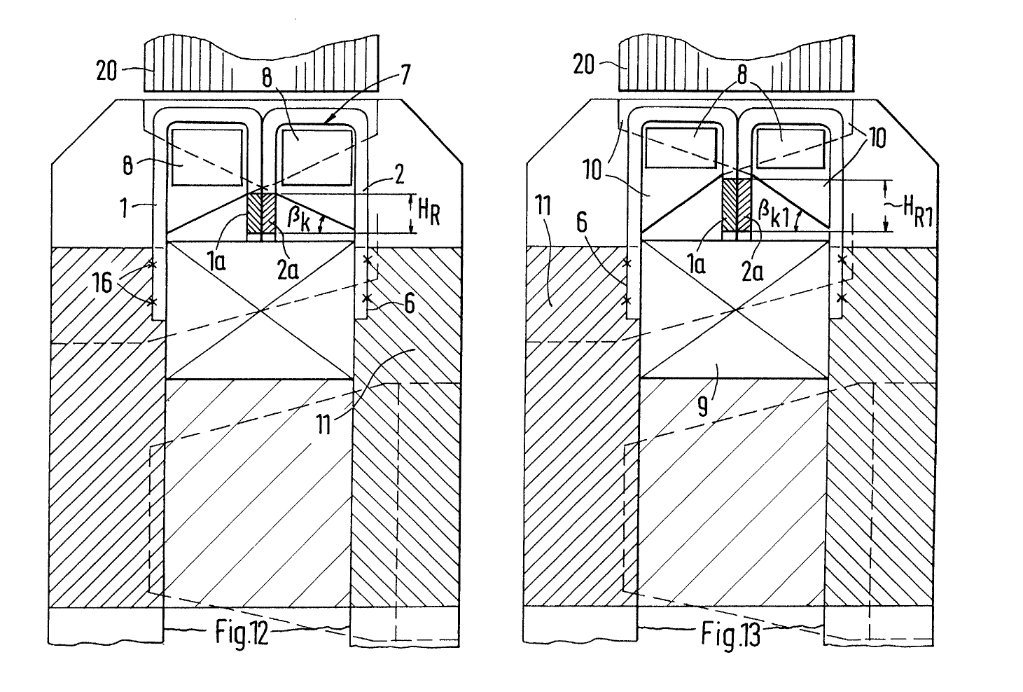

The holding rings 1a and 2a can be reinforced by flanging of the inwardly shaped projections 14 and 15. This embodiment is shown in FIGS. 8 and 9. As shown in FIGS. 10 and 11, the projections 13 formed between the holding arms 4 can be bent so that they abut on the inner sides of the claw poles 10 more or less. Therefore the stability of the holder 7 against centrifugal forces is increased.

When the claw poles 10 raise from the pole plate 11 to the tips constantly at an angle βk, a predetermined size H_{R} is provided for the radial dimension of the holding rings 1a and 2a, as shown in FIG. 2. When the claw poles raise from the plate 11 to the center, or in other words the point of the holding rings 1a and 2a, first with the greater angle βk1 and extend to the tips flatter, then for the radial dimension of the holding rings 1a and 2a a greater value H_{R1} is provided as shown in FIG. 13 with the same design of the rotor.

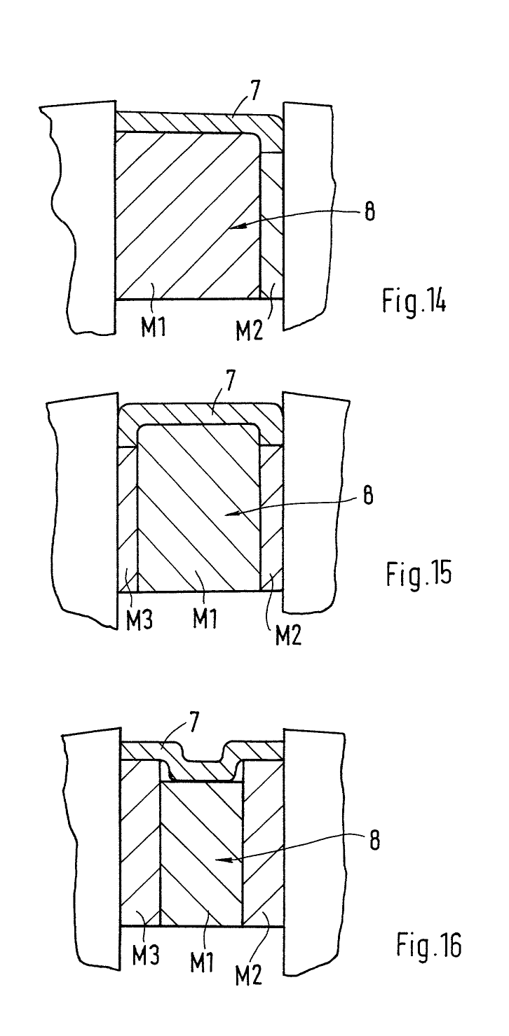

As can be seen from FIGS. 14-16 the corrugations or projections from the axial parts of the holder 7 can contribute to an axial fixation of the permanent magnets. The permanent magnets 8 can be assembled axially in a sandwich-like manner of several magnetic layers M1, M2, M3. The radially supported magnetic layers provide engaging possibilities for the corrugations or projections of the holder 7, which axially secure the assembled permanent magnet 8. The permanent magnet 8 can be also formed as a one-piece element and provided with grooves or the like, in which the corrugations or projections of the holder 7 engage.

The shown embodiments are directed to a synchronous machine with an inner rotor. The invention however can utilized for an outer rotor of a synchronous machine. The same is true for the stator of a synchronous machine.

It will be understood that each of the elements described above, or two or more together, may also find a useful application in other types of constructions differing from the types described above.

While the invention has been illustrated and described as embodied in synchronous machine in particular generator for a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A synchronous machine formed as a generator for a motor vehicle; comprising a stator; a rotor, an excitation system including a plurality of individual poles in said rotor formed as claw poles; means for compensation of stray flux in free spaces between said claw poles and including permanent magnets provided in pole plates arranged at axial ends of said rotor; a holder supporting said permanent magnets against centrifugal and axial forces, said holder being composed of two non-magnetic holding rings which centrally surround said excitation system, abut against one another and have an outer contour extending to a lower side of said claw poles; holding tongues which are bent on said holding rings in correspondence with a number of poles and extend in said free spaces to said pole plates so as to support said permanent magnets, said holding arms having free ends; holding tongues supported by said free ends of said holding arms in direction toward a rotor shaft, said holding tongues being fixed on inner sides of said pole plates.

2. A synchronous machine as defined in claim 1, wherein said inner sides of said pole plates have troughs in which said holding tongues are fixed.

3. A synchronous machine as defined in claim 1, wherein said excitation system has a single excitation coil, said holding tongues extend to an end region of said excitation coil.

4. A synchronous machine as defined in claim 2, wherein said troughs have undercuts in a radial direction, said holding tongues having a shape corresponding to a shape of said troughs.

5. A synchronous machine as defined in claim 1, wherein said holding rings together with said holding arms and said holding tongues are formed as a punched bending part of a non-ferromagnetic weldable material.

6. A synchronous machine as defined in claim 4, wherein said holding tongues are welded in said troughs with said pole plates.

7. A synchronous machine as defined in claim 1, wherein said free spaces have identical width and extend parallel to a machine axis, said holding arms and said holding tongues extending between said claw poles in ray-like manner on said holder and are bent twice.

8. A synchronous machine as defined in claim 1, wherein said free spaces between said claw poles have identical width and are differently inclined toward a machine central axis, said holding arms and said holding tongues being inclined and bent in correspondence with the inclination on said holding ring.

9. A synchronous machine as defined in claim 1, wherein said holding rings are arranged in a row near one another so that said holding arms transit directly into one another.

10. A synchronous machine as defined in claim 1, wherein said holding rings with said holding arms and said holding tongues of said holder form two receptacles per each free space which are arranged one behind the other for said permanent magnets.

11. A synchronous machine as defined in claim 1, wherein said holding rings between neighboring free spaces have portions which are bent so that they extend perpendicular to a longitudinal axis of said free spaces.

12. A synchronous machine as defined in claim 1; and further comprising means for connecting said permanent magnets to said holder, said means being means selected from the group consisting of adhesive means, form-locking means and force-transmitting means.

13. A synchronous machine as defined in claim 1, wherein said excitation system has a single excitation coil, said claw poles having sides facing said excitation coil and raising from said pole plates to a center of said claw pole steeper than a portion extending to an opposite pole plate.

14. A synchronous machine as defined in claim 1, wherein said axial parts of said holder are provided with formations for fixing permanent magnets.

15. A synchronous machine as defined in claim 14, wherein said formations are corrugations.

16. A synchronous machine as defined in claim 14, wherein said formations are projections.

17. A synchronous machine as defined in claim 14, wherein said permanent magnets are assembled of magnetic layers.

18. A synchronous machine as defined in claim 14, wherein said permanent magnets are provided with grooves.
